(19) United States
(12) Patent Application Publication
(10) Pub. No.: US 2022/0252775 A1
(43) Pub. Date: Aug. 11, 2022

(54) REDUCED GLARE LIGHTING

(71) Applicant: SIGNIFY HOLDING B.V., EINDHOVEN (NL)

(72) Inventor: QI AI, PEACHTREE CITY, GA (US)

(21) Appl. No.: 17/610,955

(22) PCT Filed: May 12, 2020
(86) PCT No.: PCT/EP2020/063210

§ 371 Date: Nov. 12, 2021

Related U.S. Application Data
(60) Provisional application No. 62/848,413, filed on May 15, 2019.

(51) Int. Cl. F21V 8/00

(52) U.S. Cl. CPC G02B 6/002; G02B 6/0045

(57) ABSTRACT

The present invention discloses a lighting structure (100) comprising a light emitting panel (102) with a planar section (110) and a cavity section (106). An optic (104) is disposed within a cavity (108) of the cavity section (106), wherein an opening (112) of the cavity section (106) is surrounded by the planar section (110), wherein the optic (104) is located distal from the opening (112) of the cavity section (106) to transfer a first portion of a light from a light source (202) toward the opening (112) of the cavity section (106) and a second portion of the light into the planar section (110).

### TECHNICAL FIELD

The present disclosure relates generally to lighting, in particular to reducing glare from light sources of lighting fixtures.

### BACKGROUND

Glare resulting from a light provided by a lighting fixture may be a source of visual discomfort. In general, glare may be related to the contrast in the intensity levels of a light provided by a light source of the lighting fixture. For example, when a light is provided by the lighting fixture, a large difference in the intensity levels of the light at different parts of the lighting fixture may cause glare. To illustrate, as a light from a light source leaves a lighting fixture, a large difference in the intensity level of the light between locations of the lighting fixture close to the light source and other locations of the lighting fixture may result in glare that causes visual discomfort. For example, the light may have a significantly higher intensity level leaving an optic of the lighting fixture than at a background area of the lighting fixture around the optic. In some cases, the level of visual discomfort experienced by a person may depend on the viewing angle of the person with respect to the different areas of the lighting fixture. Thus, a solution that reduces glare by reducing the difference in the intensity levels of the light at the lighting fixture may be desirable.

### BRIEF DESCRIPTION OF THE DRAWINGS

Reference will now be made to the accompanying figures, which are not necessarily to scale, and wherein:

FIG. 1 is a bottom perspective view of a lighting structure according to an example embodiment;

FIG. 2 is a cross-sectional view of the lighting structure of FIG. 1 according to an example embodiment;

FIG. 3 is another cross-sectional view of the lighting structure of FIG. 1 according to an example embodiment;

FIG. 4 is the cross-sectional view of the lighting structure shown in FIG. 3 including angular parameters according to an example embodiment;

FIG. 5 is a lighting fixture including the lighting structure of FIG. 1 according to an example embodiment;

FIG. 6 is a bottom perspective view of a lighting structure including multiple optics according to an example embodiment;

FIG. 7 is a lighting fixture including the lighting structure of FIG. 6 according to an example embodiment;

FIG. 8 is a bottom perspective view of a lighting structure according to another example embodiment;

FIG. 9 is a cross-sectional view of the lighting structure of FIG. 8 according to an example embodiment;

FIG. 10 is another cross-sectional view of the lighting structure of FIG. 8 according to an example embodiment;

FIG. 11 illustrates a back side of a lighting structure including multiple optics according to an example embodiment;

FIG. 12 is a bottom perspective view of a multi-panel lighting structure according to an example embodiment;

FIG. 13 is an exploded view of the multi-panel lighting structure of FIG. 12 according to an example embodiment;

FIG. 14 is a cross-sectional view of the multi-panel lighting structure of FIG. 12 according to an example embodiment;

FIG. 15 is a bottom perspective view of a multi-panel lighting structure including multiple optics according to an example embodiment; and

FIG. 16 is a lighting fixture including the multi-panel lighting structure of FIG. 15 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in multiple drawings may designate like or corresponding but not necessarily identical elements.

### DETAILED DESCRIPTION OF THE EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

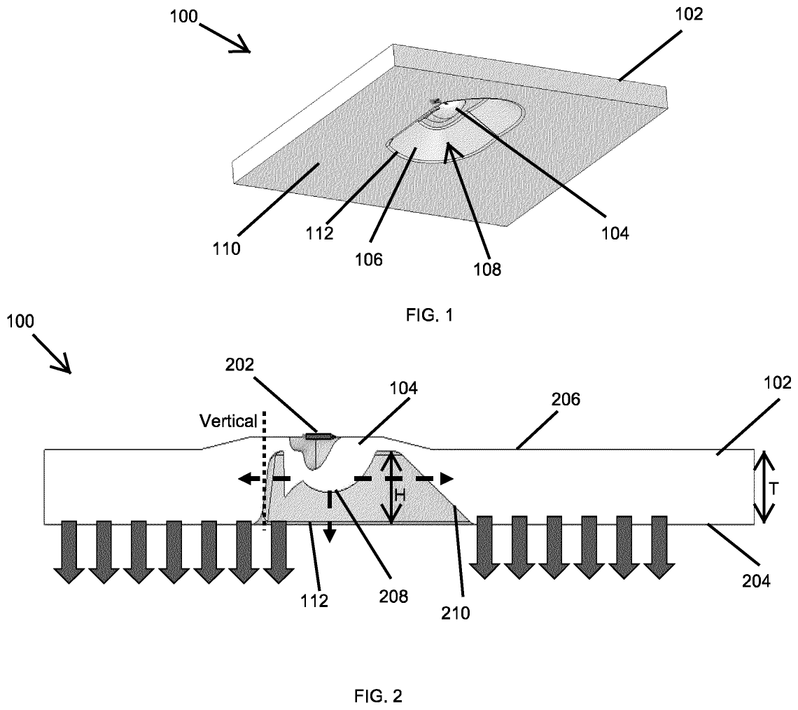

Turning now to the figures, particular embodiments are described. FIG. 1 is a bottom perspective view of a lighting structure 100 according to an example embodiment. For example, as shown in FIG. 1, the lighting structure 100 may be oriented facing an area (e.g., a ground) that is illuminated by a lighting fixture that includes the lighting structure 100. In some example embodiments, the lighting structure 100 includes a light emitting panel 102 and an optic 104 (e.g., a bubble optic). The light emitting panel 102 may include a cavity section 106 and a planar section 110. An opening 112 of the cavity section 106 may be surrounded by the planar section 110. For example, the planar section 110 may form the perimeter of the opening 112 of the cavity section 106. As shown in FIG. 1, the cavity section 106 may be formed in the planar section 110.

In some example embodiments, the optic 104 is disposed within a cavity 108 of the cavity section 106. For example, the optic 104 may be positioned within the cavity 108 distal from the opening 112 of the cavity section 106. The optic 104 may be positioned such that the lowest end of the optic 104 in the orientation of the lighting structure 100 shown in FIG. 1 is above the opening 112 of the cavity section 106. To illustrate, some of the light that exits the optic 104 is directed toward and enters the planar section through the wall of the cavity section 106 that is shared with the planar section 110, and some of the light that exits the optic 104 is directed toward and passes through the opening 112 to the area below the lighting structure 100.

In some example embodiments, the wall of the cavity section 106 may be slanted on one or more sides of the optic 104. For example, the wall of the cavity section 106 may be slanted away from the optic 104 as the wall extends towards the opening 112 of the cavity section 106. In contrast to a non-slanted wall, the slanted wall of the cavity section 106 may result in the opening 112 being relatively larger than the cavity 108, which allows a relatively larger portion of the light exiting the optic 104 to pass through the opening 112 without obstruction by the wall of the cavity section 106. In contrast to an opening of a cavity section that has a non-slanted wall, the relatively larger size of the opening 112 minimizes the reduction in the lighting provided by lighting structure 100 to the area below the lighting structure 100 while cutting-off a portion of the light to reduce glare.

Because the optic 104 is positioned within the cavity 108, a portion of the light exiting the optic 104 enters the planar section 110 through the wall of the cavity section 106. Because some of the light that enters the planar section 110 through the wall of the cavity section 106 is emitted through a surface of the planar section 110 toward the area below the lighting structure 100, the contrast between the optic 104 and the planar section 110 is reduced while minimizing the reduction in the overall light output of the lighting structure 100. Such reduced contrast may result in reduced glare being experienced by a person viewing the lighting structure 100. The reduction in glare may be more pronounced when a person views the lighting structure 100 at a viewing angle where the optic 104 is hidden from a direct view within the cavity section 106, in other words, the widest angles at which light is emitted.

In some example embodiments, the light emitting panel 102 may be made from a translucent material, such as polycarbonate or another suitable material. In some example embodiments, the optic 104 may be made from polycarbonate or another suitable material. In some example embodiments, the light emitting panel 102 and the optic 104 may be made using methods such as molding. In some example embodiments, the optic 104 may be integrally formed with the light emitting panel 102 as a single structure. Alternatively The light emitting panel 102 may be attached to the optic 104 by mechanical means or using an adhesive In some alternative embodiments, the light emitting panel 102 and the optic 104 may have different shapes and relative dimensions than shown without departing from the scope of this disclosure. As non-limiting examples, example, the light emitting panel 102 may be triangular, circular, oval, etc. As non-limiting examples, the optic 104 may be have multiple surfaces, sections, curves, height, width, etc.

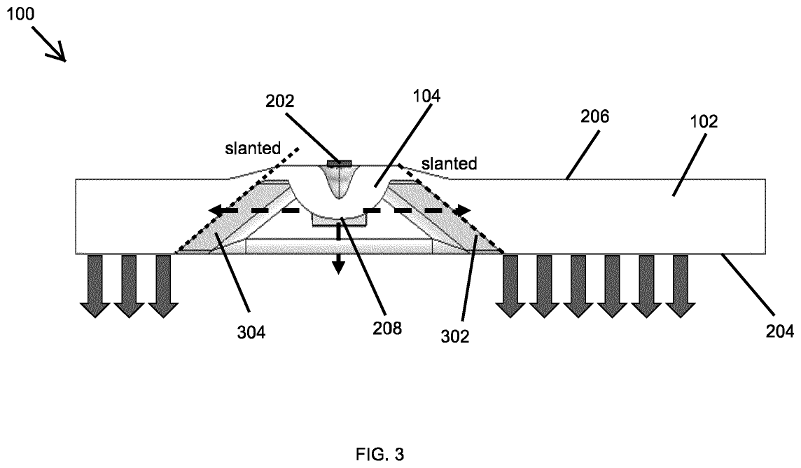

FIG. 2 is a cross-sectional view of the lighting structure 100 of FIG. 1 according to an example embodiment. FIG. 3 is another cross-sectional view of the lighting structure 100 of FIG. 1 according to an example embodiment. Referring to FIGS. 1-3, in some example embodiments, a light emitted by a light source 202 may exit the optic 104 in many directions including the illustrative example directions shown in FIGS. 2 and 3 with the dotted arrows. For example, the light source 202 (e.g., an LED light source) may be tightly coupled to the optic 104 on a back side of the lighting structure 100 such that the light emitted by the light source 202 exits through the optic 104. Some of the light that exits the optic 104 passes through the opening 112, and some of the light enters the planar section 110. For example, some of the light may enter the planar section 110 through the sections 302, 304 of the wall 210 of the cavity section 106. In general, some of the light exiting the optic 104 may enter the planar section 110 on all sides of the optic 104 that face the wall 210 of the cavity section 106.

In some example embodiments, some of the light that enters the planar section 110 may exit the planar section 110 through a front surface 204 of the planar section 110 as illustratively shown in FIGS. 2 and 3 by the thick arrows extending down from the planar section 110. For example, the front surface 204 of the planar section 110 may include a pattern and/or the planar section 110 may include a diffuse material that enables and/or facilitates some of the light that enters the planar section 110 to be emitted through the front surface 204 toward the area below the lighting structure 100. A reflective material that may be positioned at a back surface 206 of the planar section 110 may also reflect back light toward the front surface 204.

In some example embodiments, the light emitting panel 102 may have a thickness T that allows the cavity section 106 to have a height H such that a bottom end portion 208 (e.g., lowest tip) of the optic 104 is entirely inside the cavity section 106. For example, by placing the bottom end portion 208 of the optic 104 entirely inside the cavity section 106, some of the light exiting the optic 104 may be cut off by the wall 210 of the cavity section 106.

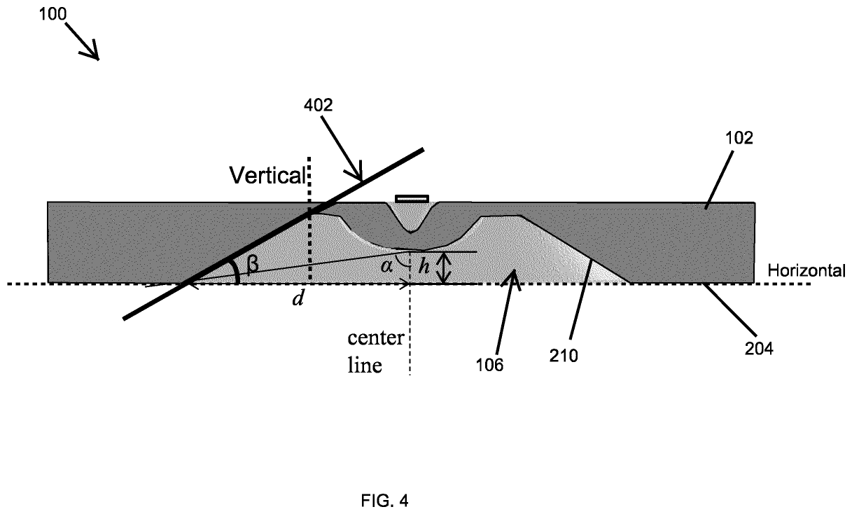

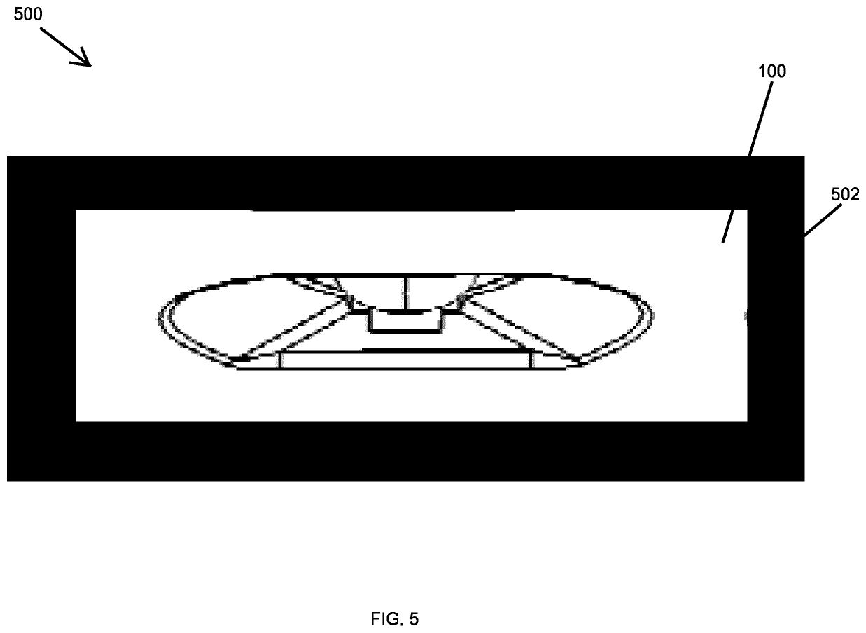

FIG. 4 is the cross-sectional view of the lighting structure shown in FIG. 3 including angular parameters according to an example embodiment. Referring to FIGS. 1-4, in some example embodiments, as the wall 210 of the cavity section 106 extends down toward the opening 112, the wall 210 may be slanted on one or more sides of the optic 104. For example, some sections, such as sections 302, 304 of the wall 210, may be slanted while one or more other sections of the wall 210 of the cavity section 106 may be substantially vertical. Alternatively, the wall 210 of the cavity section 110 may be slanted on all sides of the optic 104 that face the wall 210.

In some example embodiments, the degree of slanting of the wall 210 of the cavity section 106 may affect the amount of glare reduction that is achieved. For example, a relatively smaller slant of the wall 210 may result in more glare reduction than a relatively larger slant of the wall 210. To illustrate, a slant of the wall 210 that is too small may cut off too much of the light exiting the optic 104 and may result in the overall light distribution being impaired. On the other hand, a slant of the wall 210 that is too large may result a relatively small glare reduction and in less light exiting through the planar portion 110 because a smaller portion of the light exiting the optic 104 is cut off by the wall 210.

The cut-off angle α of the optic 104 (e.g., a bubble optic) with respect to the bottom end portion 208 may be defined as the highest angle ray emitted from the at the bottom end portion 208 of the optic 104 without touching the wall 210 of the cavity section 106. As long as the cut-off angle α is non-zero, glare reduction may be achieved because some the light that exits the optic 104 is cut off by the wall 210 of the cavity section 106 and enters the planar panel 110.

In some example embodiments, the lighting structure 100 may be designed to have a particular cut-off angle α of the optic 104 by changing one or both of the recessed depth h and the opening size d (e.g., a horizontal distance from the center line and a location on the perimeter of the opening 112 or a radius when the opening 112 is circular) of the opening 112. For example, equation (1) below can be used to calculate the cut-off angle α.

α=arctan(d/h) Eq. 1

Cut-off angles at other points on the optic 104 may be defined in a similar manner as the cut-off angle α and can be used in designing the lighting structure 100. The angle β of the wall 210 on one or more sides of the optic 104 may be defined as the angle between the slanted line 402 and the horizontal plane and may be designed to be between 0°<β≤90° based on the cut-off angle α. For example, for a particular cut-off angle α, the lighting structure 100 may be designed to have angle β of the wall 210 may affect the proportion of the light that enters the planar section 110 through the wall 210. Alternatively, the recessed depth h and/or the opening size d of the opening 112 may be designed to achieve a particular angle β of the wall 210. The reduction in glare may be higher at larger values of the angle β of the wall 210 as more light enters the wall 210.

Because some of the light from the optic 104 that enters the planar section 110 exits the planar section 110 through the front surface 204, the contrast in the brightness level of the optic 104 and the planar section 110 may be reduced resulting in reduced glare. Also, because some of the light from the optic 104 that enters the planar section 110 exits the planar section 110, some of the light that is cut off by the wall 210 contributes to the overall brightness of the light provided by the lighting structure 100, which may avoid an excessive reduction in overall brightness of the light.

FIG. 5 is a lighting fixture 500 including the lighting structure 100 of FIG. 1 according to an example embodiment. Referring to FIGS. 1-5, the lighting fixture 500 may include a frame (or a housing) 502, and the lighting structure 100 including the light source 202 shown in FIG. 2 may be positioned within the frame 502. The lighting fixture 500 may include a power source (e.g., an LED driver) that provides power to the light source 202 on a back side of or within the frame 502.

In some example embodiments, the lighting fixture 500 may be oriented as a downlight lighting fixture. For example, the lighting fixture 500 may be a garage lighting fixture or area lighting fixture. Alternatively, the lighting fixture 500 may be an uplight lighting fixture or may otherwise be installed in a different orientation.

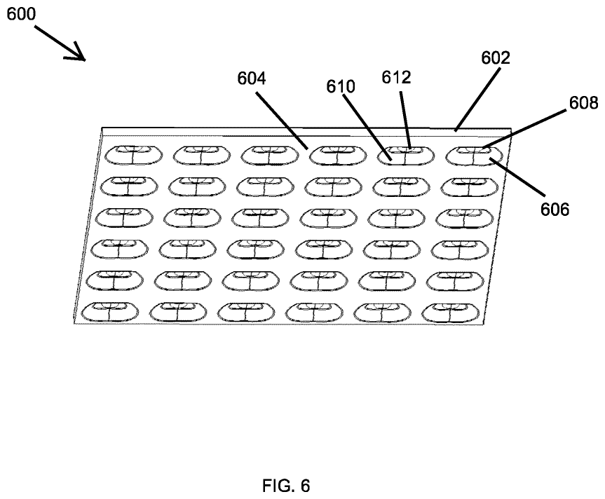

FIG. 6 is a bottom perspective view of a lighting structure 600 including multiple optics according to an example embodiment. In general, the lighting structure 600 may be similar to the lighting structure 100 except for the number of the cavity sections and corresponding optic. For example, the lighting structure 600 may be made from the same material and in a similar manner as the lighting structure 100.

In some example embodiments, the lighting structure 600 may include a light emitting panel 602 that includes a planar section 604. The light emitting panel 602 may include multiple cavity sections such as cavity sections 606, 610. The cavity sections 606, 610 may be formed in the light emitting panel 602 in a similar manner as the cavity section 106 shown in FIG. 1.

In some example embodiments, an optic may be positioned in the cavity of the individual cavity sections of the light emitting panel 602 similar to the optic 104 shown in FIG. 1. For example, an optic 608 may be positioned in the cavity section 606, and the optic 612 may be positioned in the cavity section 610. Individual light sources (e.g., LEDs) or a light source unit that includes discrete light sources may be positioned on the back side of the lighting structure 600 to emit a light into the respective optic of the cavity sections of the lighting structure 600.

In some example embodiments, each optic of the lighting structure 600 may be positioned in the respective cavity section such that the cut-off angles α of the different optics are substantially the same. For example, the dimensions of the openings of the cavity sections and the recess depth h (shown in FIG. 4) of the respective optic may be substantially the same. Further, the angle β of the wall of the different cavity sections of the lighting structure 600 may be substantially the same. In some alternative embodiments, some or all of the cut-off angles α of the different optics and/or the angle β of the respective wall of the different cavity sections may be different from each other.

Because a portion of the light that exits multiple optics enters the planar section 604 and is emitted through the front surface of the light emitting panel 602, the brightness contrast between the optics and the planar section 604 may be reduced. The reduced contrast between the optics and the planar section 604, and the physical cut-off of the light emitted from 608, 612 and other bubble optics may result in reduced glare.

In some alternative embodiments, the lighting structure 600 may have fewer or more cavity sections and corresponding optic than shown in FIG. 6 without departing from the scope of this disclosure. In some alternative embodiments, the lighting structure 600 may have a different shape than shown without departing from the scope of this disclosure. For example, the lighting structure 600 may have a different form factor than shown in FIG. 6. As non-limiting examples, the perimeter shape of the lighting structure 600 may be oval, circular, triangular, etc. As non-limiting examples, the optics of the lighting structure 600 may be different curved areas, sections, width, height, etc.

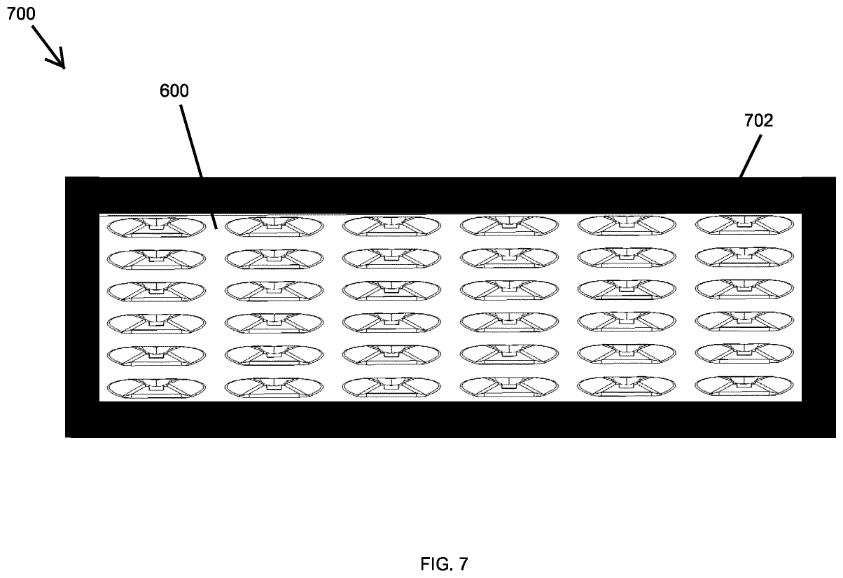

FIG. 7 is a lighting fixture 700 including the lighting structure 600 of FIG. 6 according to an example embodiment. Referring to FIGS. 6 and 7, the lighting fixture 700 may include a frame (or a housing) 702, and the lighting structure 600 may be positioned within the frame 702. The lighting fixture 700 may include a power source (e.g., an LED driver) that provides power to the light source of the lighting fixture 700 on a back side of or within the frame 702.

In some example embodiments, the lighting fixture 700 may be oriented as a downlight lighting fixture. For example, the lighting fixture may be a garage lighting fixture or area lighting fixture. Alternatively, the lighting fixture 700 may be an uplight lighting fixture or may otherwise be installed in a different orientation.

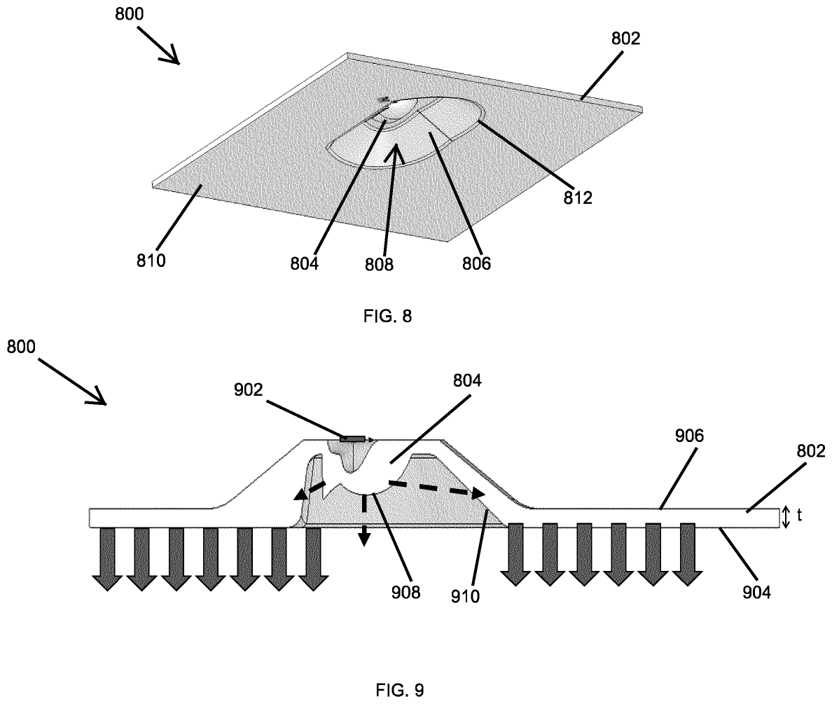

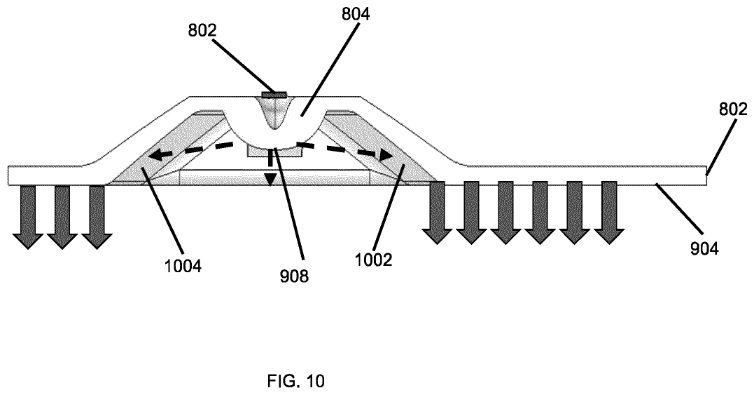

FIG. 8 is a bottom perspective view of a lighting structure 800 according to another example embodiment. FIG. 9 is a cross-sectional view of the lighting structure 800 of FIG. 8 according to an example embodiment. FIG. 10 is another cross-sectional view of the lighting structure 800 of FIG. 8 according to an example embodiment. In some example embodiments, the lighting structure 800 may result in reduced glare in a similar manner as the lighting structure 100 shown in FIG. 1. In FIGS. 8-10, the lighting structure 800 may be oriented facing an area (e.g., a ground) that is illuminated light from by a lighting fixture that includes the lighting structure 800.

Referring to FIGS. 8-10, in some example embodiments, the lighting structure 800 includes a light emitting panel 802 and an optic 804 (e.g., a bubble optic). The light emitting panel 802 may include a cavity section 806 and a planar section 810. An opening 812 of the cavity section 806 may be surrounded by the planar section 810. For example, the planar section 810 may form the perimeter of the opening 812 of the cavity section 806.

In some example embodiments, the optic 804 is disposed within a cavity 808 of the cavity section 806. For example, the optic 804 may be positioned within the cavity 808 distal from the opening 812 of the cavity section 806. The optic 804 may be positioned such that the lowest end of the optic 804 in the orientation of the lighting structure 800 shown in FIGS. 8-10 is above the opening 812 of the cavity section 106. To illustrate, some of the light that exits the optic 804 is directed toward and enters the planar section 810 through the wall of the cavity section 806, and some of the light that exits the optic 804 is directed toward and passes through the opening 812 to the area below the lighting structure 800.

In some example embodiments, some of the light that exits the optic 804 enters the planar section 810 through the wall 910 of the cavity section 806 in a similar manner as described above with respect to the lighting structure 100. A front surface 904 of the planar section 810 may have a pattern/texture to extract out light through the front surface 904 to the area below the planar section 801. Alternatively or in addition, the planar section 810 may be diffused to extract the light out through the front surface 904. Some of the light that enters the planar section 810 may exit through the front surface 904 of the planar section 810 as illustrated by thick arrows extending down from the planar section 810. A reflective material that may be positioned at the back of a surface 906 of the planar section 810 may also reflect back light toward the front surface 904. Because some of the light that exits the optic 804 is emitted through the front surface 904, the brightness contrast between the optic 804 and the planar section 810 is reduced resulting in reduced glare in a similar manner as described with respect to the lighting structure 100.

In contrast to the planar section 110 of the lighting structure 100, thickness t of the planar section 810 between the front surface 904 and the back surface 906 may be smaller than the thickness T of the planar section 110, which may result in reduced material cost while achieving a reduction in glare. In general, the cut-off angle of the optic 804 and other related parameters may be determined in a similar manner as described above with respect to the lighting structure 100.

In some example embodiments, the lighting structure 800 may be made from the same types of material and in similar manner as the lighting structure 100 of FIG. 1.

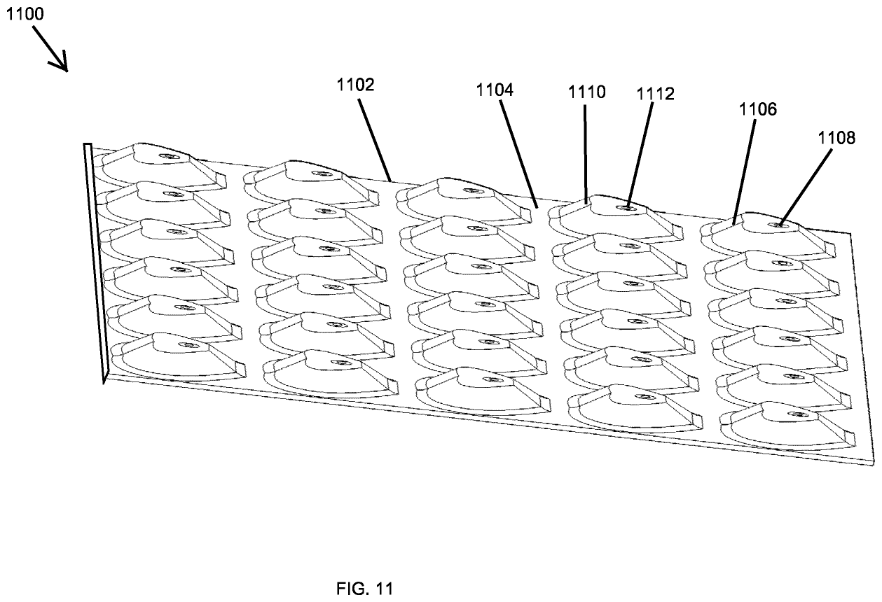

FIG. 11 illustrates a back side of a lighting structure 1100 including multiple optic according to an example embodiment. In general, the lighting structure 1100 may be similar to the lighting structure 800 except for the number of the cavity sections and corresponding optic. For example, the lighting structure 1100 may be made from the same material and in a similar manner as the lighting structure 800.

In some example embodiments, the lighting structure 800 may include a light emitting panel 1102 that includes a planar section 1104. The light emitting panel 1102 may include multiple cavity sections such as cavity sections 1106, 1110. In some example embodiments, an optic may be positioned in the cavity of the individual cavity sections of the light emitting panel 1102 similar to the optic 804 shown in FIG. 8. Light sources (e.g., LEDs), such as the light source 1108, 1112, may be positioned to emit a light into the respective optic of the cavity sections of the lighting structure 1100. In some alternative embodiments, the light sources, such as the light source 1108, 1112, may be included in a single light source unit that is positioned on the back side of the light emitting panel 1102 such that individual light sources emit a light into the respective optic.

In some example embodiments, the optic of the lighting structure 1100 may be positioned in the respective cavity sections, such as the cavity sections 1106, 1110, such that the cut-off angles α of the different optics (as described with respect to the lighting structure 100) are substantially the same. Alternatively, the lighting structure 800 may be designed such that some of the cut-off angles α of the different optics are different. Further, the angle β of the wall of some cavity sections of the lighting structure 1100 may be substantially the same or different from others. Because portions of the lights that exit multiple optics enter the planar section 1104 and are emitted through the front surface of the light emitting panel 1102, the brightness contrast between the optics and the planar section 1104 may be reduced. The reduced contrast between the optics and the planar section 1104 may result in reduced glare.

In some alternative embodiments, the lighting structure 1100 may have fewer or more cavity sections and corresponding optic than shown in FIG. 11 without departing from the scope of this disclosure. In some alternative embodiments, the lighting structure 1100 may have a different shape than shown without departing from the scope of this disclosure. For example, the lighting structure 1100 may have a different form factor than shown in FIG. 11. As non-limiting examples, the perimeter shape of the lighting structure 1100 may be oval, circular, triangular, etc. As non-limiting examples, the optics of the lighting structure 1100 may be different curved areas, sections, width, height, etc.

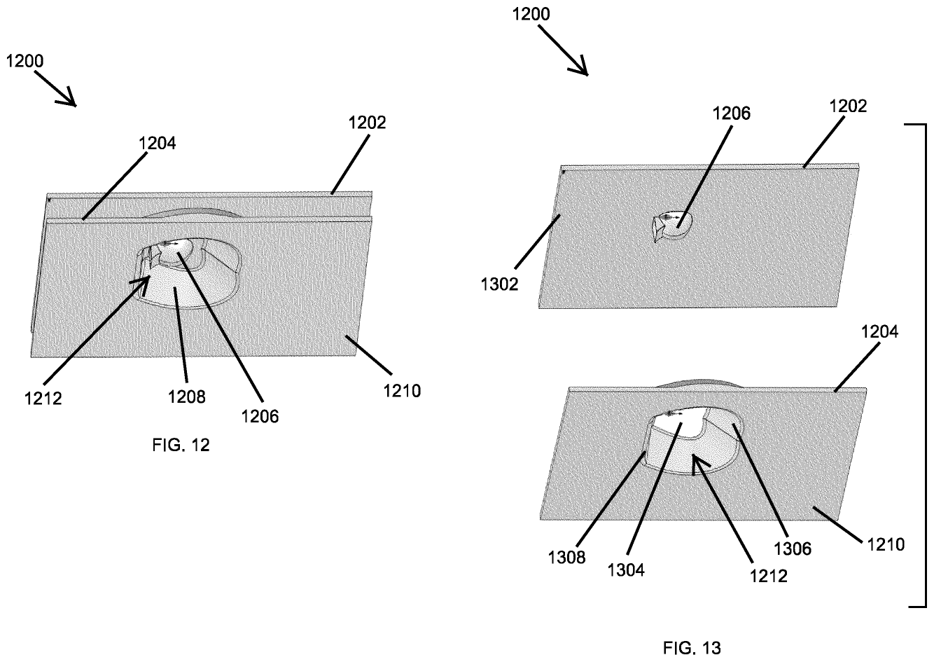

FIG. 12 is a bottom perspective view of a multi-panel lighting structure 1200 according to an example embodiment. FIG. 13 is an exploded view of the multi-panel lighting structure 1200 of FIG. 12 according to an example embodiment. Referring to FIGS. 12 and 13, in some example embodiments, the multi-panel lighting structure 1200 includes a base light emitting panel 1202 and a shield light emitting panel 1204. The base light emitting panel 1202 may include a planar section 1302 and an optic 1206. For example, the planar section 1302 and the optic 1206 may be integrally formed as a single unit.

In some example embodiments, the shield light emitting panel 1204 may include a cavity section 1208 and a planar section 1210. A front opening 1308 of the cavity section 1208 may be surrounded by the planar section 1210. For example, the planar section 1210 may form the perimeter of the front opening 1308 of the cavity section 106. The cavity section 1208 and the planar section 1210 may be integrally formed as a single unit using injection molding.

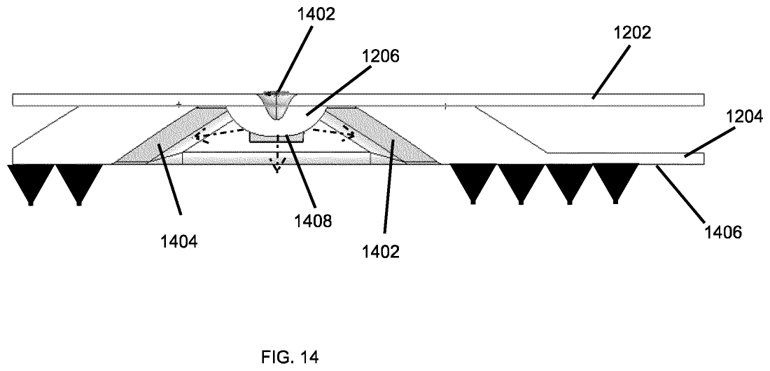

In some example embodiments, the base light emitting panel 1202 and the shield light emitting panel 1204 may be attached to each other such that the optic 1206 is positioned in the cavity 1212 of the cavity section 1208 of the shield light emitting panel 1204. For example, the optic 1206 may be inserted into the cavity 1212 through a back opening 1304 of the cavity section 1208. The optic 1206 may be positioned in the cavity 1212 such that a portion of the light exiting the optic 1206 is directed to and enters the planar section 1210 of the shield light emitting panel 1204 through the wall 1306 of the cavity section 1208 as shown by the dotted arrows in FIG. 14. Some of the light that enters the planar section 1210 through the wall 1306 of the cavity section 1208 may exit through the front surface 1406 of the planar section 1210 as shown be the thick arrows.

FIG. 14 is a cross-sectional view of the multi-panel lighting structure 1200 of FIG. 12 according to an example embodiment. Referring to FIGS. 12-14, the shield light emitting panel 1204 may be attached to the base light emitting panel 1202 using, for example, an adhesive such that the optic 1206 is positioned in the cavity 1212 of the cavity section 1208. Alternatively, the shield light emitting panel 1204 may be attached to the base light emitting panel 1202 using other methods as can be contemplated by those of ordinary skill in the art with the benefit of this disclosure. A portion of the planar section 1202 may be spaced from a portion of the planar section 1406 as more clearly shown in FIG. 14.

In some example embodiments, the light emitted by the light source 1402 (e.g., an LED light source) may be directed into the optic 1206 from the back side of the lighting structure 1200. The lighting structure 1200 may be designed such that a glare reduction corresponding to a particular cut-off angle α of the optic 1206 is achieved. For example, the cut-off angle α of the optic 1206 may correspond to the cut-off angle α described with respect to the lighting structure 100. To illustrate, equation (1) above may be used to determine the cut-off angle α of the optic 1206 based on the relevant dimensions of the lighting structure 1200. The one or more sections (e.g., sections 1402, 1404) of the wall 1306 may be slanted at an angle β as described above.

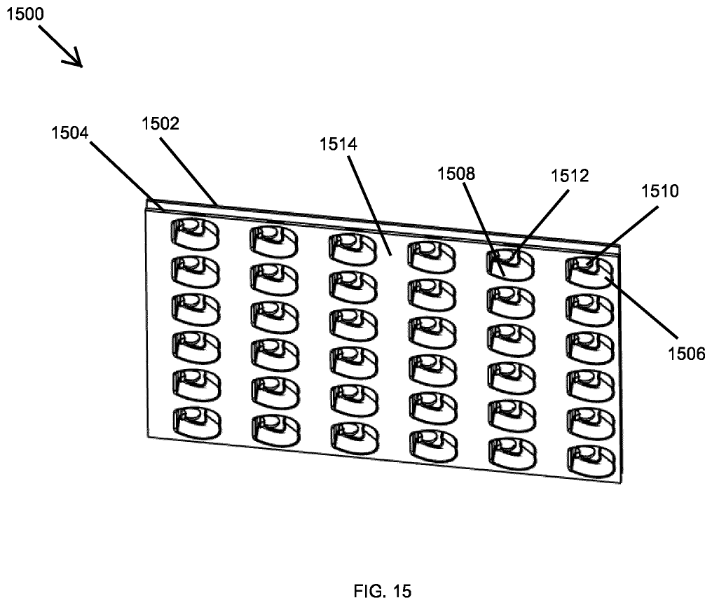

FIG. 15 is a bottom perspective view of a multi-panel lighting structure 1500 including multiple optics according to an example embodiment. The multi-panel lighting structure 1500 may include a base light emitting panel 1502 and a shield light emitting panel 1504. The base light emitting panel 1502 may correspond to the base light emitting panel 1202 of FIG. 12 with the primary difference that the base light emitting panel 1502 includes multiple optics such as the optics 1510, 1512. The shield light emitting panel 1504 may correspond to the shield light emitting panel 1204 of FIG. 12 with the primary difference that the shield light emitting panel 1504 includes multiple cavity sections such as the cavity sections 1506, 1508. Each optic of the base light emitting panel 1502 may be positioned in a cavity of a respective cavity section of the shield light emitting panel 1504 in a similar manner as described with the optic 1206 of the lighting structure 1200. The front openings of the cavity sections of the shield light emitting panel 1504 may be surrounded by the planar section 1514 of the shield light emitting panel 1504.

In some alternative embodiments, the lighting structure 1500 may have a different form factor than shown in FIG. 15. As non-limiting examples, the perimeter shape of the lighting structure 1500 may be oval, circular, triangular, etc. As non-limiting examples, the optics of the lighting structure 1500 may be different curved areas, sections, width, height, etc.

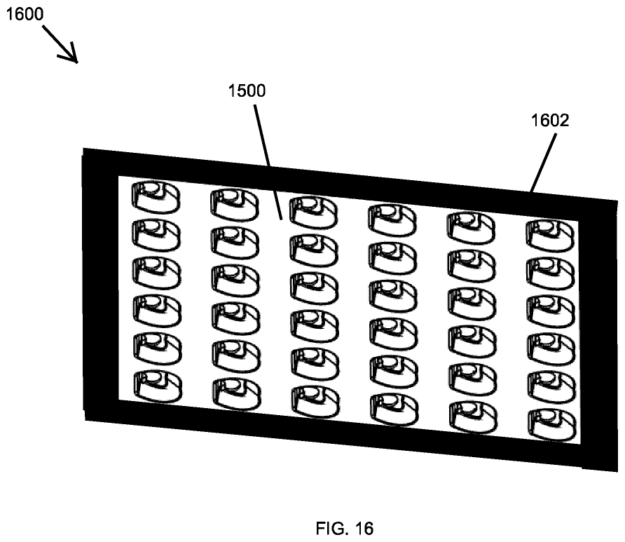

FIG. 16 is a lighting fixture 1600 including the multi-panel lighting structure 1500 of FIG. 15 according to an example embodiment. The lighting fixture 1600 may include a frame (or a housing) 1602, and the multi-panel lighting structure 1500 may be positioned within the frame 1602. Individual light sources or a light source unit may be positioned on the back side of the lighting structure 1500 to emit lights into the optics that are positioned in the respective cavity sections.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures. (not sure here all different types of bubbled optic that needs glare control were mentioned. The optic doesn't have to be that specific shape. If this paragraph means the above I mentioned, I think I am good with it.)

1. A lighting structure, comprising:
a light source,
a light emitting panel having a planar section and a cavity section; and
an optic disposed within a cavity of the cavity section, wherein an opening of the cavity section is surrounded by the planar section,
wherein the light source is coupled to the optic on a back side of the lighting structure and said optic is located distal from the opening of the cavity section, light emitted from the light source exits the optic into the cavity section to transfer a first portion of said light toward the opening of the cavity section and a second portion of said light into the planar section.

2. The lighting structure of claim 1, wherein the cavity section is formed in the planar section.

3. The lighting structure of claim 1, wherein the light emitting panel and the optic are integrally formed.

4. The lighting structure of claim 1, wherein a wall of the cavity section is slanted on one or more sides of the optic.

5. A lighting fixture, comprising:
A light source,
a light emitting panel having a planar section and a cavity section;
an optic disposed within a cavity of the cavity section, wherein an opening of the cavity section is surrounded by the planar section,
wherein the light source is coupled to the optic on a back side of the lighting fixture and said optic is located distal from the opening of the cavity section, light emitted from the light source exits the optic into the cavity section; and
said light source emits light,
wherein the light source is positioned outside of the cavity of the cavity section and proximal to the optic, wherein the optic is positioned to transfer a first portion of said light toward the opening of the cavity section and a second portion of said light into the planar section.

6. A lighting structure, comprising:
a base light emitting panel having a first planar section and an optic; and
a shield light emitting panel having a second planar section and a cavity section, wherein an opening of the cavity section is surrounded by the second planar section, wherein the optic is disposed within a cavity of the cavity section distal from the opening of the cavity section to transfer a first portion of a light from a light source toward the opening of the cavity section and a second portion of the light into the second planar section.

7. The lighting structure of claim 6, wherein a portion of the first planar section is spaced from a portion of the second planar section.

8. The lighting structure of claim 6, wherein the second planar section and the cavity section are integrally formed.

9. The lighting structure of claim 6, wherein a wall of the cavity section is slanted on one or more sides of the optic.
